(19) United States
(12) Patent Application Publication
(10) Pub. No.: US 2020/0295419 A1
(43) Pub. Date: Sep. 17, 2020

(54) COOLING MEMBER AND POWER STORAGE MODULE

(71) Applicants: AUTONETWORKS TECHNOLOGIES, LTD., Yokkaichi-shi Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Hideyuki KUBOKI, Yokkaichi-shi, Mie (JP); Hiroki HIRAI, Yokkaichi-shi, Mie (JP); Makoto HIGASHIKOZONO, Yokkaichi-shi, Mie (JP); Akihisa HOSOE, Osaka-shi, Osaka (JP); Yoshiyuki HIROSE, Osaka-shi, Osaka (JP); Tomoharu TAKEYAMA, Osaka-shi, Osaka (JP); Eiichi KOBAYASHI, Osaka-shi, Osaka (JP)

(21) Appl. No.: 16/084,133

(22) PCT Filed: Mar. 7, 2017
(86) PCT No.: PCT/JP2017/008906

§ 371 Date: Sep. 11, 2018

(30) Foreign Application Priority Data
Mar. 16, 2016 (JP) 2016-052242

(51) Int. Cl. H01M 10/6569; H01M 10/6555; H01M 10/6557

(52) U.S. Cl. CPC H01M 10/6569; H01M 10/6557; H01M 10/6555

(57) ABSTRACT

A cooling member includes an enclosing member including sheet members that are connected in a liquid tight manner, refrigerant enclosed in the enclosing member, and a medium where the refrigerant moves within the enclosing member. The medium includes an evaporation section where the refrigerant is evaporated and turned into gas, the enclosing member includes a condensation section in which the refrigerant that is in a gaseous state is condensed and turned into liquid. The medium includes acceleration means that accelerates movement of the refrigerant that is in a liquid state to the evaporation section.

### CROSS REFERENCE TO RELATED APPLICATIONS

This application claims the priority of Japanese patent application JP2016-052242 filed on Mar. 16, 2016, the entire contents of which are incorporated herein.

### TECHNICAL FIELD

The technology described in this specification relates to a cooling member and a power storage module.

### BACKGROUND ART

A cooling member including a sealed container and refrigerant enclosed therein has been known (refer Japanese Unexamined Patent Application Publication No. 2002-372388). The refrigerant absorbs heat from a heat source and is evaporated and turned into steam in the evaporation section of the sealed container. The steam moves within the sealed container to a condensation section and dissipates and is condensed into liquid. The liquid refrigerant moves within the enclosed container to the evaporation section.

Wicks are included within the sealed container to accelerate movement of the liquid refrigerant. The liquid refrigerant is moved to the evaporation section by capillary phenomenon caused by the wicks.

However, in the above configuration, if a sufficient amount of refrigerant is not moved to the evaporation section, the amount of liquid refrigerant may be insufficient in the evaporation section. Then, the heat from the heat source cannot be absorbed effectively and cooling properties of the cooling member may be lowered.

The present technology described in this specification has been completed in view of the circumstances described above. It is an object of the present technology to improve cooling properties of a cooling member.

### SUMMARY

The technology described in this specification is a cooling member including an enclosing member including sheet members that are connected in a liquid tight manner, refrigerant enclosed in the enclosing member, and a medium arranged in the enclosing member and including a path through which the refrigerant moves, and the medium includes an evaporation section where the refrigerant is evaporated and turned into gas, the enclosing member includes a condensation section where the refrigerant that is in a gaseous state is condensed and turned into liquid, and the medium includes acceleration means that accelerates movement of the refrigerant that is in a liquid state to the evaporation section.

According to the above configuration, movement of the refrigerant, which is condensed and turned into liquid, from the condensation section to the evaporation section can be accelerated. Accordingly, the liquid state refrigerant is effectively supplied to the evaporation section and cooling efficiency of the cooling member can be improved.

According to the present technology described in this specification, cooling properties of a cooling member can be improved.

### BRIEF DESCRIPTION OF THE DRAWINGS

FIG. 1 is a cross-sectional view illustrating a power storage module according to a first embodiment.

FIG. 2 is an exploded perspective view illustrating the cooling member.

FIG. 3 is a cross-sectional view illustrating refrigerant.

FIG. 4 is a plan view illustrating refrigerant according to a second embodiment.

FIG. 5 is a plan view illustrating refrigerant according to a third embodiment.

FIG. 6 is a plan view illustrating refrigerant according to a fourth embodiment.

### MODES FOR CARRYING OUT THE INVENTION

### First Embodiment

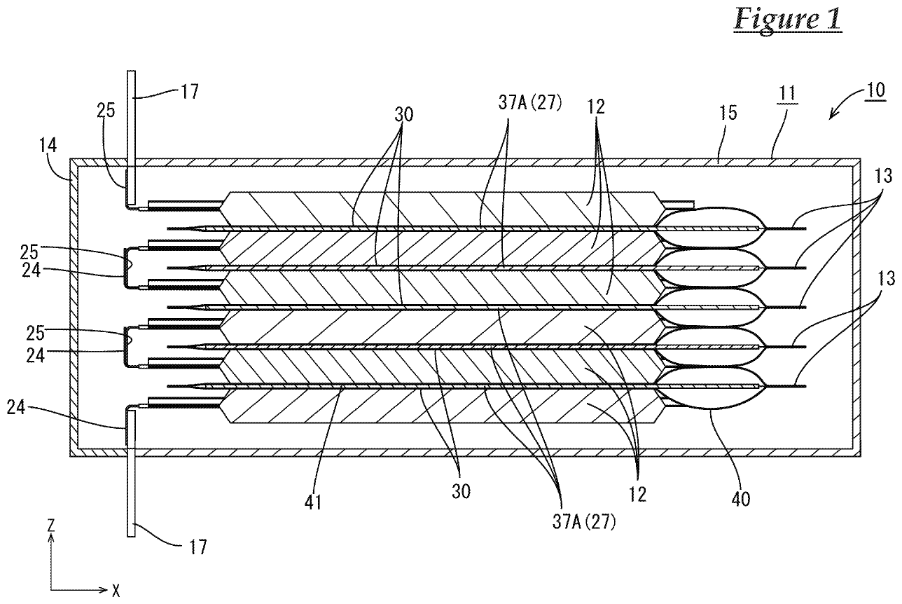

A first embodiment according to a technology described in this specification will be described with reference to FIGS. 1 to 3. A power storage module 10 according to this embodiment includes a casing 11, power storage elements 12 arranged in the casing 11, and cooling members 13 that are arranged in the casing 11 and in contact with a part of an outer surface of each of the power storage elements 12. In the following description, an X direction represents a right side, a Y direction represents a front side, and a Z direction represents an upper side. Symbols or numerals are put on one or some of the parts having the same shape and no symbols or numerals may be put on the rest of them.

The power storage module 10 is arranged such that a stacking direction in which the power storage elements 12 and the cooling members 13 are arranged faces an upper side. The upper side may be an upper side in a vertical direction or may be substantially a vertical upper side.

As illustrated in FIG. 1, the casing 11 is a substantially rectangular parallelepiped shape as a whole. The casing 11 includes a first case 14 and a second case 15. The first case 14 is open toward a right side and has a substantially rectangular shape seen from the right side. The second case 15 is mounted on a right side with respect to the first case 14 and has a substantially rectangular cross-sectional shape and has a box shape opening toward a left side. A left side end of the second case 15 has a shape following that of a right side end of the first case 14.

The first case 14 and the second case 15 may be made of any material such as synthetic resin or metal. The first case 14 and the second case 15 may be made of different materials or the same material.

The first case 14 and the second case 15 may be connected with a known method such as a locking structure including a locking member and an locked member, a screwing structure, and bonding with adhesive. The first case 14 and the second case 15 that are made of metal may be connected with a known method such as laser welding and brazing. In this embodiment, the first case 14 and the second case 15 are not connected in a liquid tight manner. However, the first case 14 and the second case 15 may be connected in a liquid tight manner.

A pair of power terminals 17 are mounted on a left end side section of the casing 11 and one of them projects upward and the other projects downward. The power terminals 17 are formed of a metal plate.

The power storage element 12 includes a pair of battery laminating sheets and a power storage component, which is not illustrated, between the laminating sheets, and edge sections of the battery laminating sheets are bonded in a liquid tight manner with a known method such as heat-welding. As illustrated in FIG. 1, a positive terminal 24 and a negative terminal 25 that are formed of a thin metal foil extend from an inside to an outside of the battery laminating sheets while being in contact with inner surfaces of the battery laminating sheets in a liquid tight manner. The positive terminals 24 and the negative terminals 25 project from left ends of the power storage elements 12 and are arranged in a front-rear direction at intervals. The positive terminals 24 and the negative terminals 25 are electrically connected to the power storage components, respectively.

As illustrated in FIG. 1, the power storage elements 12 (six in this embodiment) are arranged in an up-down direction. The power storage elements 12 arranged adjacent in the up-down direction include one positive terminal 24 next to another negative terminal 25 and one negative terminal 25 next to another positive terminal 24. The positive terminal 24 and the negative terminal 25 that are next to each other are bent to be closer to each other and overlapped with each other and the positive terminal 24 and negative terminal 25 that are overlapped in a right-left direction are electrically connected to each other with a known method such as laser welding, ultrasonic welding, and brazing. Thus, the power storage elements 12 are connected in series.

In this embodiment, secondary batteries such as lithium ion secondary batteries and nickel hydride batteries or capacitors such as electric double layer capacitors and lithium ion capacitors may be used as the power storage elements 12, and any power storage elements 12 can be used as appropriate.

The cooling member 13 includes refrigerant 27 and an enclosing member 26 that is formed in a liquid tight manner and the refrigerant 27 is enclosed inside the enclosing member 26. An amount of the refrigerant 27 enclosed in the enclosing member 26 is determined as appropriate. In this embodiment, the refrigerant 27 is absorbed by a medium 37A, which will be described later, and the symbol representing the refrigerant 27 illustrates the medium 37A. One or some may be selected from a group of perfluorocarbon, hydrofluoroether, hydrofluoroketone, fluorine inert liquid, water, and alcohol such as methanol and ethanol and can be used as the refrigerant 27. The refrigerant 27 may have an insulating property or may have conductivity. The cooling member 13 has a length dimension in the right-left direction that is greater than the length dimension of the power storage element 12.

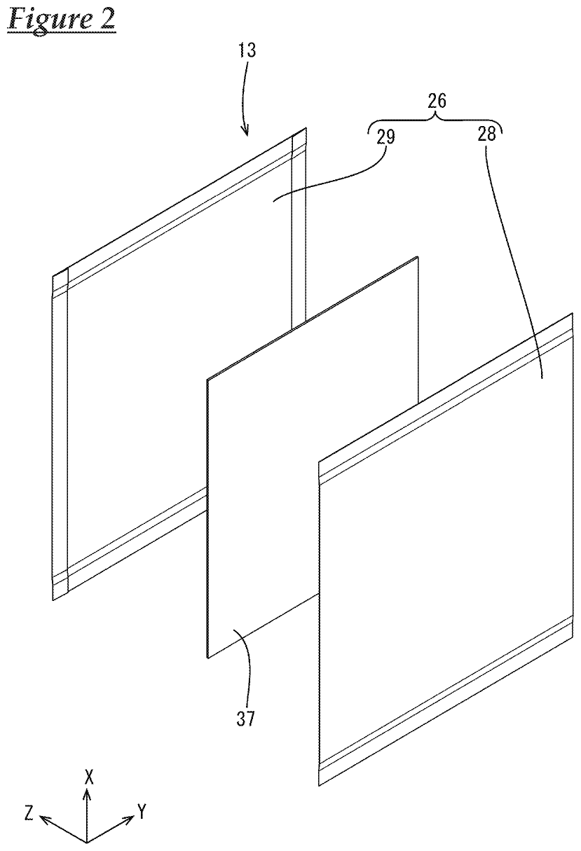

As illustrated in FIG. 2, the enclosing member 26 includes a first sheet member 28 and a second sheet member 29 having a substantially rectangular shape and the two sheet members are connected to each other in a liquid tight manner with a known method such as bonding, deposition, or welding.

Each of the first sheet member 28 and the second sheet member 29 includes a metal sheet and synthetic resin films on both surfaces of the metal sheet. Any metal such as aluminum, aluminum alloy, copper, or copper alloy may be selected as appropriate as the metal of the metal sheet. Any synthetic resin such as polyolefin such as polyethylene and polypropylene, polyester such as polybutylene terephthalate, and polyetylene terephthalate, and polyamide such as nylon 6 and nylon 6, 6 may be selected as appropriate as the synthetic resin of the synthetic resin film.

The enclosing member 26 of this embodiment is obtained by overlapping a surface of the first sheet member 28 having the synthetic resin film thereon and a surface of the second sheet member 29 having a synthetic resin film thereon and bonding the sheet members with heat-welding.

The enclosing member 26 has a contact section 30 on an outer surface thereof and the contact section 30 is in contact with the power storage element 12 to transfer heat therebetween.

The cooling member 13 includes a condensation section 40 at a projected section thereof projecting rightward from the power storage element 12. The refrigerant 27 that is in a gaseous state is condensed and changed to liquid with phase transition in the condensation section 40. In the condensation section 40, the refrigerant 27 that is in a gaseous state and has relatively high temperature dissipates and is changed to liquid with phase transition within the enclosing member 26. The released heat of condensation is transferred to the first sheet member 28 and the second sheet member 29 and the heat dissipates from the outer surfaces of the first sheet member 28 and the second sheet member 29 to the outside of the cooling member 13.

The medium 37A is included inside the enclosing member 26. The medium 37A is a substantially rectangular sheet. The medium 37A includes minute spaces through which the refrigerant 27 that is in a liquid state and the refrigerant 27 that is in a gaseous state pass.

The medium 37A is disposed in the enclosing member 26 over an area substantially equal to or larger than that of the contact section 30 of the enclosing member 26. In this embodiment, the medium 37A is disposed within the enclosing member 26 over an area larger than that of the contact section 30.

The medium 37A includes an evaporation section 41 that corresponds to the contact section 30 of the enclosing member 26. The refrigerant 27 that is in a liquid state is evaporated by heat from the power storage element 12 and turns into gas in the evaporation section 41. The refrigerant 27 that is evaporated absorbs heat of vaporization from the power storage element 12 and thus, the power storage element 12 is cooled down.

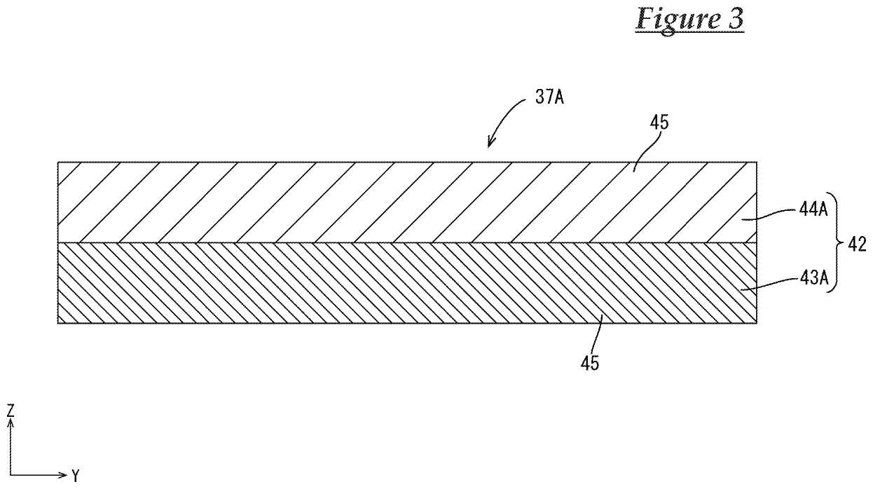

FIG. 3 illustrates a cross-sectional view of the medium 37A. The medium 37A includes a high affinity section 43A having a high affinity for the refrigerant 27 that is in a liquid state and a low affinity section 44A that is disposed on an upper surface of the high affinity section 43A. In other words, the high affinity section 43A and the low affinity section 44A are stacked in a thickness direction of the medium 37A (the up-down direction). In this embodiment, a configuration in which the high affinity section 43A and the low affinity section 44A are stacked is acceleration means 42 that accelerates movement of the refrigerant 27 that is in a liquid state to the evaporation section 41.

The high affinity section 43A and the low affinity section 44A may be bonded with an adhesive layer or with heat fusing. The sections may be bonded with material through which the refrigerant 27 that is in a liquid state and the refrigerant 27 that is in a gaseous state can pass. The sections may be stacked with any other methods as necessary.

The low affinity section 44A has a lower affinity for the refrigerant 27 that is in a liquid state than the high affinity section 43A. In this embodiment, the low affinity section 44A repels the refrigerant 27 that is in a liquid state.

The high affinity section 43A is formed of material that can absorb the refrigerant 27. The high affinity section 43A may be formed of a cloth obtained by processing material that can absorb the refrigerant 27 into fibers or may be formed of a non-woven cloth. Examples of the non-woven cloth may include a fiber sheet, web (a thin film sheet made of only fibers), and batt (fibers of blanket). The material of the high affinity section 43A may be natural fibers or synthetic fibers made of synthetic resin or may include both of the natural fibers and the synthetic fibers. In this embodiment, the high affinity section 43A includes a resin cloth 45 made of synthetic fibers that can absorb the refrigerant 27.

The low affinity section 44A is formed of material that repels the refrigerant 27. The low affinity section 44A may be formed of a cloth obtained by processing material that repels the refrigerant 27 into fibers or formed of a non-woven cloth. Examples of the non-woven cloth may include a fiber sheet, web (a thin film sheet made of only fibers), and batt (fibers of blanket). The material of the low affinity section 44A may be natural fibers or synthetic fibers made of synthetic resin or may include both of the natural fibers and the synthetic fibers. In this embodiment, the low affinity section 44A includes a resin cloth 45 made of synthetic fibers that repels the refrigerant 27.

In this embodiment, a thickness dimension of the high affinity section 43A is same or substantially same as a thickness dimension of the low affinity section 44A. The thickness dimension of the high affinity section 43A may be greater than that of the low affinity section 44A. The thickness dimension of the low affinity section 44A may be greater than that of the high affinity section 43A.

The high affinity section 43A extends to the condensation section 40 of the enclosing member 26. Therefore, the refrigerant 27 that is turned from gas into liquid with phase transition is absorbed by the high affinity section 43A in the condensation section 40. The refrigerant 27 absorbed by the high affinity section 43A promptly moves within the high affinity section 43A and reaches the evaporation section 41 of the medium 37A.

The liquid state refrigerant 27 that reaches the evaporation section 41 receives heat from the power storage element 12 via the contact section 30. Accordingly, the power storage element 12 is cooled down.

Furthermore, the refrigerant 27 absorbs heat of vaporization and turns into gas in the evaporation section 41. Accordingly, the power storage element 12 is further cooled down.

The low affinity section 44A repels the refrigerant 27 that is in a liquid state and therefore, the low affinity section 44A is dry. The refrigerant 27 that is in a gaseous state promptly moves to the low affinity section 44A. The low affinity section 44A also extends to the condensation section 40 of the enclosing member 26. Therefore, the refrigerant 27 that is in a gaseous state promptly moves within the low affinity section 44A to the evaporation section 41.

### Operations and Effects of Embodiment

Next, operations and effects of this embodiment will be described. The cooling member 13 according to this embodiment includes the enclosing member 26 including the sheet members 28, 29 that are bonded in a liquid tight manner, the refrigerant 27 that is enclosed within the enclosing member 26, and the medium 37A that is disposed within the enclosing member and has paths through which the refrigerant 27 moves. The medium 37A includes the evaporation section 41 where the refrigerant 27 is evaporated and turned into gas. The enclosing member 26 includes the condensation section 40 where the refrigerant 27 in a gaseous state is condensed and turned into liquid. The medium 37A includes the acceleration means 42 that accelerates movement of the liquid state refrigerant 27 to the evaporation section 41.

According to the above configuration, movement of the refrigerant 27, which is condensed and turned into liquid, from the condensation section 40 to the evaporation section 41 can be accelerated. Accordingly, the liquid state refrigerant 27 is effectively supplied to the evaporation section 41 and cooling efficiency of the cooling member 13 can be improved.

According to this embodiment, the medium 37A includes the high affinity section 43A having an affinity for the liquid state refrigerant 27 and the low affinity section 44A having an affinity for the liquid state refrigerant 27 lower than that of the high affinity section 43A.

According to the above configuration, the refrigerant 27 that is in a liquid state is likely to be present in the high affinity section 43A than the low affinity section 44A. Therefore, the refrigerant 27 that is in a gaseous state is relatively likely to be present in the low affinity section 44A and the refrigerant 27 that is in a liquid state is relatively likely to be present in the high affinity section 43A. Accordingly, the refrigerant 27 that is in a gaseous state effectively moves within the low affinity section 44A and the refrigerant 27 that is in a liquid state effectively moves within the high affinity section 43A. As a result, the moment of the liquid state refrigerant 27 to the evaporation section 41 is accelerated and the cooling efficiency of the cooling member 13 can be improved.

According to this embodiment, the low affinity section 44A has a property of repelling the liquid state refrigerant 27.

According to the above configuration, the refrigerant 27 that is in a liquid state is repelled by the low affinity section 44A and the refrigerant 27 that is in a gaseous state is likely to be present in the low affinity section 44A. Accordingly, moving efficiency of the refrigerant 27 that is in a gaseous state within the low affinity section 44A is improved. A greater amount of the refrigerant 27 that is in a liquid state is present within the high affinity section 43A. As a result, a sufficient amount of the liquid state refrigerant 27 moves to the evaporation section 41 and the cooling efficiency of the cooling member 13 can be improved.

According to this embodiment, the medium 37A is formed in a sheet and the high affinity section 43A and the low affinity section 44A are stacked in the thickness direction of the medium 37A.

According to the above configuration, the liquid state refrigerant 27 receives heat from the heat source and is evaporated in the high affinity section 43A. Then, the gaseous state refrigerant 27 promptly moves to the low affinity section 44A that is disposed on the high affinity section 43A. Accordingly, the movement of the liquid state refrigerant 27 is less likely to be blocked by the gaseous state refrigerant 27 in the high affinity section 43A. As a result, the movement of the liquid state refrigerant 27 within the high affinity section 43A is accelerated and the cooling efficiency of the cooling member 13 can be improved.

According to this embodiment, the medium 37A includes the resin cloth 45 made of synthetic fibers.

According to the above configuration, the material of the synthetic fibers is properly selected to adjust the affinity for the liquid state refrigerant 27 easily.

The power storage module 10 of this embodiment includes the cooling member 13, and the power storage element 12 including an outer surface at least a part of which is in contact with the cooling member 13.

According to the above configuration, the power storage element 12 can be cooled down effectively by the cooling member 13.

### Second Embodiment

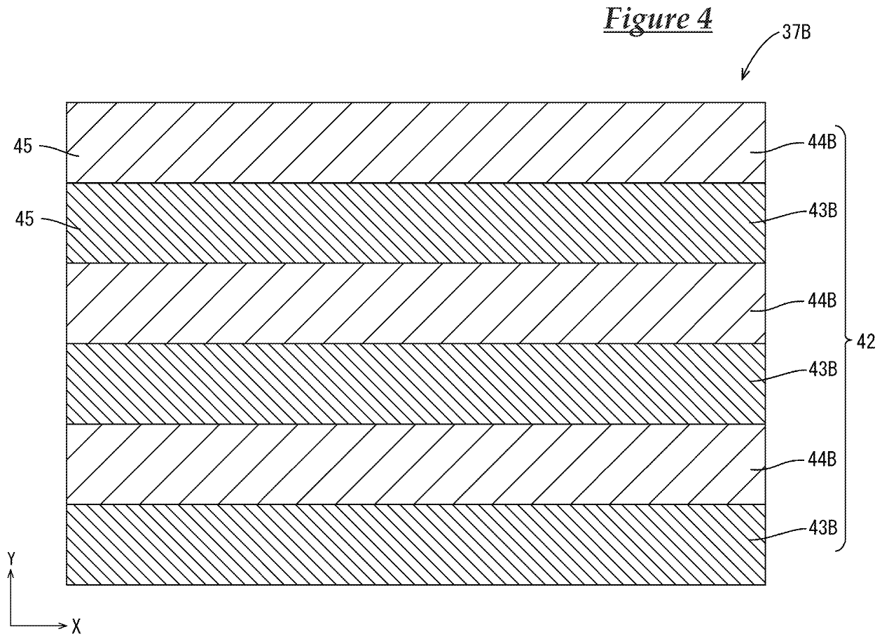

Next, the cooling member 13 of a second embodiment will be described with reference to FIG. 4. As illustrated in FIG. 4, a medium 37B has a rectangular shape elongated in the right-left direction. The right end portion of the medium 37B is arranged in the condensation section 40 of the enclosing member. Approximately four fifth of the medium 37B in the left end portion is the evaporation section 41 that is disposed corresponding to the contact section 30.

The medium 37B includes multiple (three in this embodiment) high affinity sections 43B and multiple (three in this embodiment) low affinity sections 44B that are arranged alternately in the front-rear direction. Each of the high affinity sections 43B and the low affinity sections 44B has an elongated shape elongated in the right-left direction. The number of the high affinity sections 43B may be same as or different from the number of the low affinity sections 44B. In this embodiment, a configuration in which the high affinity sections 43B and the low affinity sections 44B are arranged in the front-rear direction is the acceleration means 42.

In this embodiment, the front-rear direction length dimension of the high affinity section 43B is same as or substantially same as that of the low affinity section 44B. One of the front-rear direction length dimension of the high affinity section 43B and that of the low affinity section 44B may be greater than the other one.

In this embodiment, the right-left direction length dimension of the high affinity section 43B is same as or substantially same as that of the low affinity section 44B. One of the right-left direction length dimension of the high affinity section 43B and that of the low affinity section 44B may be greater than the other one.

In this embodiment, the low affinity section 44B has a property of repelling the liquid state refrigerant 27.

Configurations other than the above are substantially same as those of the first embodiment and the same symbols are put on the same parts and they will not be described.

In this embodiment, the medium 37B is formed in a sheet and includes the high affinity sections 43 and the low affinity sections 44B. The high affinity sections 43 extend from the evaporation section 41 of the medium 37B toward the condensation section 40 of the enclosing member. The low affinity sections 44B arranged adjacent to the high affinity sections 43B and extend from the evaporation section 41 of the medium 37B toward the condensation section 40 of the enclosing member.

According to the above configuration, the high affinity sections 43B extend from the evaporation section 41 of the medium 37B to the condensation section 40 of the enclosing member. Therefore, the refrigerant 27 that turns into liquid in the condensation section 40 effectively moves within the high affinity sections 43B to the evaporation section 41.

The refrigerant 27 that moves within the high affinity sections 43B to the evaporation section 41 is changed from liquid into gas with phase transition in the evaporation section 41. The refrigerant 27 that turns into gas can promptly move from the high affinity section 43B to the low affinity section 44B because the high affinity sections 43B and the low affinity sections 44B are arranged adjacent to each other.

The low affinity sections 44B extend from the evaporation section 41 of the medium 37B to the condensation section 40 of the enclosing member. Therefore, the refrigerant 27 that turns into gas effectively moves within the low affinity sections 44B from the evaporation section 41 to the condensation section 40.

According to the above configuration, a path for the gaseous state refrigerant 27 and a path for the liquid state refrigerant 27 are separately provided. Therefore, the moving efficiency of the gaseous state refrigerant 27 can be improved and the moving efficiency of the liquid state refrigerant 27 can be also improved.

According to this embodiment, the low affinity sections 44B has a property of repelling the liquid state refrigerant 27.

According to the above configuration, the refrigerant 27 that turns into liquid is repelled by the low affinity section 44B and the gaseous state refrigerant 27 is likely to be present in the low affinity section 44B. Accordingly, the moving efficiency of the gaseous state refrigerant 27 within the low affinity section 44B is improved. A greater amount of the liquid state refrigerant 27 is likely to be present in the high affinity section 43B. As a result, a sufficient amount of the liquid state refrigerant 27 can move to the evaporation section 41, and the cooling efficiency of the cooling member 13 can be improved.

### Third Embodiment

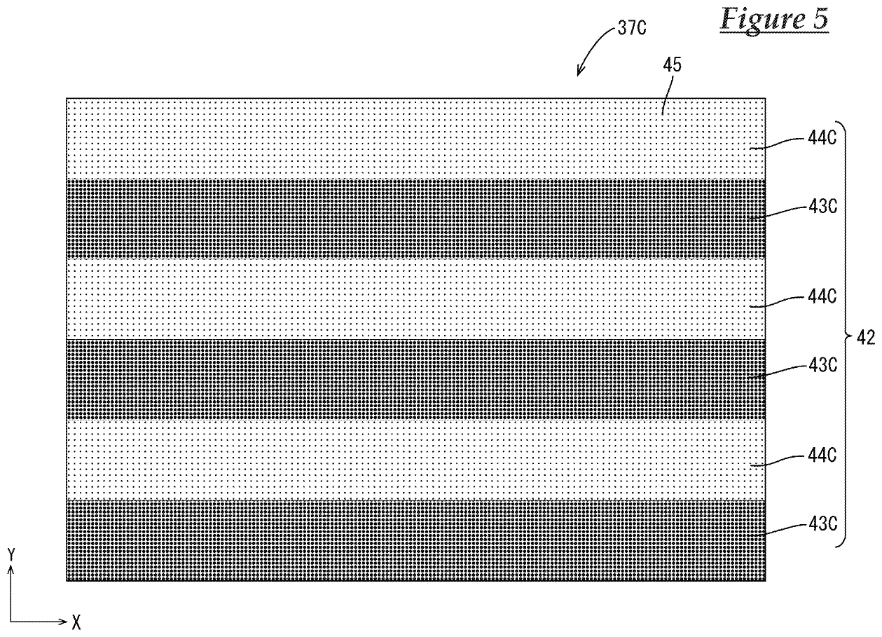

Next, the cooling member 13 according to a third embodiment will be described with reference to FIG. 5. The cooling member 13 according to the third embodiment includes a low affinity section 44C and a high affinity section 43C that are made of synthetic fibers having an affinity for the liquid state refrigerant 27. The synthetic fibers of the high affinity section 43C have a density greater than that of the synthetic fibers of the low affinity section 44C.

The density of the synthetic fibers of the high affinity section 43C may be set different from the density of the synthetic fibers of the low affinity section 44C by changing the weight of the synthetic fibers per a unit area, that is, the mass of the sheet per a unit area.

In one medium 37C, the high affinity section 43C may be pressed with pressure greater than pressure with which the low affinity section 44C is pressed such that the density of the synthetic fibers of the high affinity section 43C may be increased than the density of the synthetic fibers of the low affinity section 44C.

Configurations other than the above are substantially same as those of the second embodiment and the same symbols are put on the same parts and they will not be described.

The medium 37C of this embodiment includes the high affinity section 43C having an affinity for the liquid state refrigerant 27 and the low affinity section 44C having a lower affinity for the liquid state refrigerant 27 compared to the high affinity section 43C. The density of the synthetic fibers of the high affinity section 43C differs from the density of the synthetic fibers of the low affinity section 44C.

In a configuration including the medium 37C formed of synthetic fibers having a relatively high affinity for the liquid state refrigerant 27, the density of the synthetic fibers of the high affinity section 43C is set high and the density of the synthetic fibers of the low affinity section 44C is set low to form the high affinity section 43C and the low affinity section 44C in the medium 37C.

In a configuration including the medium 37C formed of synthetic fibers having a relatively low affinity for the liquid state refrigerant 27, the density of the synthetic fibers of the high affinity section 43C is set low and the density of the synthetic fibers of the low affinity section 44C is set high to form the high affinity section 43C and the low affinity section 44C in the medium 37C.

Thus, according to the above configuration, the high affinity section 43C and the low affinity section 44C can be formed in the medium 37C with a simple method of providing the synthetic fibers with different densities.

### Fourth Embodiment

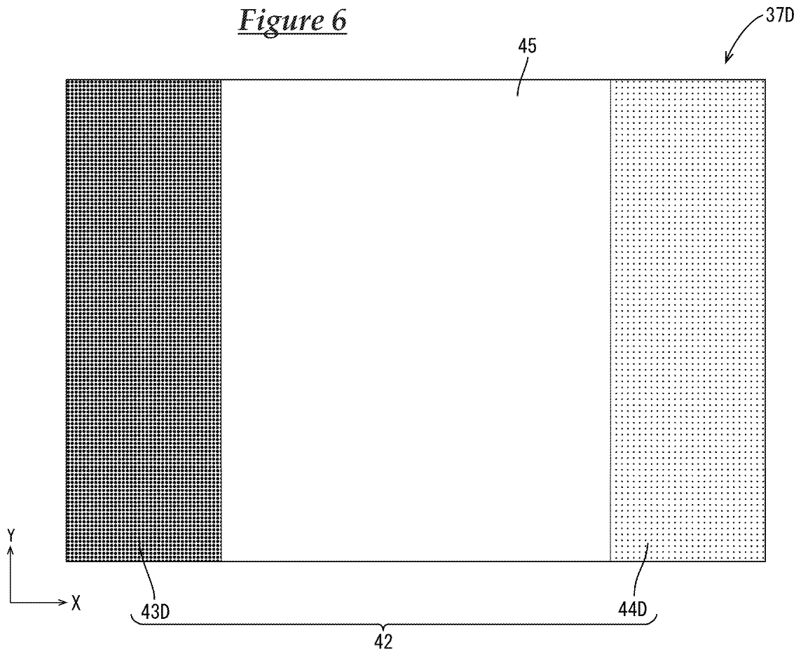

Next, the cooling member 13 according to a fourth embodiment will be described with reference to FIG. 6. A medium 37D according to this embodiment is formed in a rectangular shape elongated in the right-left direction. The right end section of the medium 37D is arranged in the condensation section 40. Approximately four fifth of the medium 37D in the left end portion of the length dimension thereof with respect to the right-left direction is the evaporation section 41 that is disposed corresponding to the contact section 30.

Approximately one fifth of the medium 37D in the left end portion of the length dimension thereof with respect to the right-left direction is a high affinity section 43D.

In this embodiment, a configuration including the high affinity section 43D in the evaporation section 41 and a low affinity section 44D on a condensation section 40 side is the acceleration means 42.

The low affinity section 44D and the high affinity section 43D of the cooling member 13 are formed of the synthetic fibers having an affinity for the liquid state refrigerant 27 and the density of the synthetic fibers of the high affinity section 43D is smaller than the density of the synthetic fibers of the low affinity section 44D.

Configurations other than the above are substantially same as those of the first embodiment and the same symbols are put on the same parts and they will not be described.

In this embodiment, the medium 37D includes a low affinity section 44D near the condensation section 40 and a high affinity section 43D that is a different section from the low affinity section 44D and in the evaporation section 41.

According to the above configuration, the refrigerant 27 that is in a liquid state can effectively move within the high affinity section 43D to the evaporation section 41 since the high affinity section 43D is included in the evaporation section 41. An amount of the liquid state refrigerant 27 is relatively small in the section of the medium 37D near the condensation section 40 because the low affinity section 44D is included in the section near the condensation section 40. Accordingly, the refrigerant 27 that is in a gaseous state can effectively move toward the condensation section 40. As a result, the cooling efficiency of the cooling member 13 can be improved.

According to this embodiment, the density of synthetic fibers forming the high affinity section 43D differs from the density of synthetic fibers forming the low affinity section 44D.

In a configuration including the medium 37D formed of synthetic fibers having a relatively high affinity for the liquid state refrigerant 27, the density of synthetic fibers is set high in the high affinity section 43D and the density of synthetic fibers is set low in the low affinity section 44D such that the high affinity section 43D and the low affinity section 44D are formed in the medium 37D.

In a configuration including the medium 37D formed of synthetic fibers having a relatively low affinity for the liquid state refrigerant 27, the density of synthetic fibers is set low in the high affinity section 43D and the density of synthetic fibers is set high in the low affinity section 44D such that the high affinity section 43D and the low affinity section 44D are formed in the medium 37D.

Thus, according to the above configuration, the high affinity section 43D and the low affinity section 44D can be formed in the medium 37D with a simple method of providing different densities with the synthetic fibers.

### Other Embodiments

The present technology described in this specification is not limited to the embodiments, which have been described using the foregoing descriptions and the drawings. For example, embodiments described below are also included in the technical scope of the present technology described in this specification.

Following configurations may be preferable for embodiments of the technology described in this specification.

The medium may include a high affinity section having an affinity for the refrigerant that is in a liquid state and a low affinity section having a lower affinity for the refrigerant that is in a liquid state compared to the high affinity section.

According to the above configuration, the refrigerant that is in a liquid state is likely to be present in the high affinity section than the low affinity section. Therefore, the refrigerant that is in a gaseous state is relatively likely to be present in the low affinity section and the refrigerant that is in a liquid state is relatively likely to be present in the high affinity section. Accordingly, the refrigerant that is in a gaseous state effectively moves within the low affinity section and the refrigerant that is in a liquid state effectively moves within the high affinity section. As a result, the moment of the liquid state refrigerant to the evaporation section is accelerated and the cooling efficiency of the cooling member can be improved.

The low affinity section may have a property of repelling the refrigerant that is in a liquid state.

According to the above configuration, the refrigerant that is in a liquid state is repelled by the low affinity section and the refrigerant that is in a gaseous state is likely to be present in the low affinity section. Accordingly, moving efficiency of the refrigerant that is in a gaseous state within the low affinity section is improved. A greater amount of the refrigerant that is in a liquid state is present within the high affinity section. As a result, a sufficient amount of the liquid state refrigerant moves to the evaporation section and the cooling efficiency of the cooling member can be improved.

The medium may be formed in a sheet, and the high affinity section and the low affinity section may be stacked in a thickness direction of the medium.

According to the above configuration, the liquid state refrigerant receives heat from the heat source and is evaporated in the high affinity section. Then, the gaseous state refrigerant promptly moves to the low affinity section that is disposed on the high affinity section. Accordingly, the movement of the liquid state refrigerant is less likely to be blocked by the gaseous state refrigerant in the high affinity section. As a result, the movement of the liquid state refrigerant within the high affinity section is accelerated and the cooling efficiency of the cooling member can be improved.

The medium may be formed in a sheet, and the medium may include the high affinity section that extends from the evaporation section of the medium toward the condensation section of the enclosing member and the low affinity section that is adjacent to the high affinity section and extends from the evaporation section of the medium toward the condensation section of the enclosing member.

According to the above configuration, the high affinity sections extend from the evaporation section of the medium to the condensation section of the enclosing member. Therefore, the refrigerant that turns into liquid in the condensation section effectively moves within the high affinity sections to the evaporation section.

The refrigerant that moves within the high affinity sections to the evaporation section is changed from liquid into gas with phase transition in the evaporation section. The refrigerant that turns into gas can promptly move from the high affinity section to the low affinity section because the high affinity sections and the low affinity sections are arranged adjacent to each other.

The low affinity sections extend from the evaporation section of the medium to the condensation section of the enclosing member. Therefore, the refrigerant that turns into gas effectively moves within the low affinity sections from the evaporation section to the condensation section.

According to the above configuration, a path for the gaseous state refrigerant and a path for the liquid state refrigerant are separately provided. Therefore, the moving efficiency of the gaseous state refrigerant can be improved and the moving efficiency of the liquid state refrigerant can be also improved.

The medium may be formed in a sheet, and the medium may include the low affinity section in a section thereof near the condensation section and the high affinity section in a section that is different from the low affinity section and in the evaporation section.

According to the above configuration, the refrigerant that is in a liquid state can effectively move within the high affinity section to the evaporation section since the high affinity section is included in the evaporation section. An amount of the liquid state refrigerant is relatively small in the section of the medium near the condensation section because the low affinity section is included in the section near the condensation section. Accordingly, the refrigerant that is in a gaseous state can effectively move toward the condensation section. As a result, the cooling efficiency of the cooling member can be improved.

The medium may include a resin cloth made of synthetic fibers.

According to the above configuration, the material of the synthetic fibers is properly selected to adjust the affinity for the liquid state refrigerant easily.

The medium may include a high affinity section having an affinity for the refrigerant that is in a liquid state and a low affinity section having a low affinity for the refrigerant that is in a liquid state, and a density of the synthetic fibers included in the high affinity section may differ from a density of the synthetic fibers included in the low affinity section.

In a configuration including the medium formed of synthetic fibers having a relatively high affinity for the liquid state refrigerant, the density of the synthetic fibers of the high affinity section 4 is set high and the density of the synthetic fibers of the low affinity section is set low to form the high affinity section and the low affinity section in the medium.

In a configuration including the medium formed of synthetic fibers having a relatively low affinity for the liquid state refrigerant, the density of the synthetic fibers of the high affinity section is set low and the density of the synthetic fibers of the low affinity section is set high to form the high affinity section and the low affinity section in the medium.

Thus, according to the above configuration, the high affinity section and the low affinity section can be formed in the medium with a simple method of providing the synthetic fibers with different densities.

The technology described in this specification is a power storage module including the above cooling member, and a power storage element having an outer surface at least a part of which is in contact with the cooling member.

According to the above configuration, the power storage element can be cooled down by the cooling member effectively.

In the first embodiment, the first sheet member 28 and the second sheet member 29 of the cooling member 13 are laminating films each including a metal sheet and synthetic resin layered on both surfaces of the metal sheet. However, configurations of the first sheet member 28 and the second sheet member 29 may not be limited thereto. Each of the first sheet member and the second sheet member may be configured such that synthetic resin is layered on one surface of the metal sheet. Each of the first sheet member and the second sheet member may be formed of a metal sheet. The first sheet member and the second sheet member that are formed of metal sheets can be connected in a liquid tight manner with bonding, welding, and brazing. The first sheet member and the second sheet member may be formed of synthetic resin sheets. Any synthetic resin such as polyolefin such as polyethylene and polypropylene, polyester such as polybutylene terephthalate and polyethylene terephthalate, and polyamide such as nylon 6 and nylon 6, 6 may be selected as appropriate as the synthetic resin of the synthetic resin film.

In the above embodiments, one medium is arranged in the enclosing member 26. However, it is not limited thereto and two or more media may be arranged in the enclosing member 26.

In the above embodiments, the enclosing member 26 is formed by connecting the first sheet member 28 and the second sheet member 29. However, it is not limited thereto and the enclosing member 26 may be formed from one sheet member. The sheet member may be folded and edges thereof may be connected in a liquid tight manner to form the enclosing member 26. Three or more sheet members may be connected in a liquid tight manner to form the enclosing member 26.

In the first embodiment, the medium 37A is on an inner side of the condensation section 40 of the enclosing member 26. However, it is not limited thereto and the medium 37A may not be disposed on an inner side of the condensation section 40 but may be disposed only in a section corresponding to the contact section 30.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### EXPLANATION OF SYMBOLS

10: power storage module
12: power storage element
13: cooling member
26: enclosing member
27: refrigerant
28: first sheet member
37A, 37B, 37C, 37D: medium
40: condensation section
41: evaporation section
42: acceleration means
43A, 43B, 43C, 43D: high affinity section
44A, 44B, 44C, 44D: low affinity section
45: resin cloth

1. A cooling member comprising:
an enclosing member including sheet members that are connected in a liquid tight manner;
refrigerant enclosed in the enclosing member; and
a medium arranged in the enclosing member and including a path through which the refrigerant moves, wherein
the medium includes an evaporation section where the refrigerant is evaporated and turned into gas,
the enclosing member includes a condensation section where the refrigerant that is in a gaseous state is condensed and turned into liquid, and
the medium includes acceleration means that accelerates movement of the refrigerant that is in a liquid state to the evaporation section.

2. The cooling member according to claim 1, wherein
the medium includes a high affinity section having an affinity for the refrigerant that is in a liquid state and a low affinity section having a lower affinity for the refrigerant that is in a liquid state compared to the high affinity section.

3. The cooling member according to claim 2, wherein the low affinity section has a property of repelling the refrigerant that is in a liquid state.

4. The cooling member according to claim 2, wherein
the medium is formed in a sheet, and
the high affinity section and the low affinity section are stacked in a thickness direction of the medium.

5. The cooling member according to claim 2, wherein
the medium is formed in a sheet, and
the medium includes the high affinity section that extends from the evaporation section of the medium toward the condensation section of the enclosing member and the low affinity section that is adjacent to the high affinity section and extends from the evaporation section of the medium toward the condensation section of the enclosing member.

6. The cooling member according to claim 2, wherein
the medium is formed in a sheet, and
the medium includes the low affinity section in a section thereof near the condensation section and the high affinity section in a section that is different from the low affinity section and in the evaporation section.

7. The cooling member according to claim 1, wherein the medium includes a resin cloth made of synthetic fibers.

8. The cooling member according to claim 7, wherein
the medium includes a high affinity section having an affinity for the refrigerant that is in a liquid state and a low affinity section having a low affinity for the refrigerant that is in a liquid state, and
a density of the synthetic fibers included in the high affinity section differs from a density of the synthetic fibers included in the low affinity section.

9. A power storage module comprising:
the cooling member according to claim 1; and
a power storage element having an outer surface at least a part of which is in contact with the cooling member.

10. A power storage module comprising:
the cooling member according to claim 2; and
a power storage element having an outer surface at least a part of which is in contact with the cooling member.
